(19) United States
(12) Patent Application Publication
(10) Pub. No.: US 2024/0287274 A1
(43) Pub. Date: Aug. 29, 2024

(54) METHOD AND SYSTEM FOR EXTRACTING CONTAMINANTS FROM WASTE POLYMERS

(71) Applicant: PYROWAVE INC., Montreal (CA)

(72) Inventors: Jocelyn Doucet, Montreal (CA); Jean-Philippe Laviolette, Montreal (CA); Ali Eslami, La Prairie (CA)

(21) Appl. No.: 18/294,456

(22) PCT Filed: Aug. 3, 2022
(86) PCT No.: PCT/IB2022/057214

§ 371 Date: Feb. 1, 2024

Related U.S. Application Data
(60) Provisional application No. 63/203,872, filed on Aug. 3, 2021.

(51) Int. Cl. C08J 11/08; B01D 61/14

(52) U.S. Cl. CPC C08J 11/08; B01D 61/145; B01D 61/147; B01D 61/149; B01D 2311/06; B01D 2315/16; B01D 2317/025; C08J 2300/30

(57) ABSTRACT

A method for extracting a target polymer from a contaminated polymer compound, including dissolving the contaminated polymer compound using a given solvent, thereby obtaining a dissolved polymer mixture; microfiltering the dissolved polymer mixture to remove non-soluble impurities having a size larger than a size of the target polymer from the dissolved polymer mixture, thereby obtaining a permeate microfiltered polymer solution; and extracting the given solvent from the permeate microfiltered polymer solution, thereby obtaining a feedstock of the target polymer.

### FIELD

The present technology pertains to the field of polymer purifying and recycling.

### BACKGROUND

Recycling of waste plastics is complex. The main limitation is related to the difficulty in restoring virgin-like properties so that recycled polymers can be performing identically to virgin resins.

There are various families of plastic recycling technologies that can be regrouped in three groups: a) mechanical recycling (i.e. optical infra-red based, density separation, wet flotation, centrifugal separation), b) physico-chemical technologies (i.e. dissolution or solvent extraction) and c) chemical recycling technologies, involving thermo-degradation (like pyrolysis or gasification) or chemolysis (like hydrolysis or methanolysis) converting polymers into by-products, including monomers and other hydrocarbons.

Recycling of polymers is difficult primarily because it is difficult to restore the input waste into an output polymer of comparable quality to virgin polymers (in the case of mechanical and physico-chemical technologies), or the ability to produce an output product (like monomers or chemical feedstocks) that can be used in existing chemical processes producing polymers or products of equal quality to virgin (in the case of thermo-degradation or chemolysis technologies).

One of the reasons that makes recycling of polymer waste difficult in practice is the presence of contaminants that have to be properly removed from the polymer matrix. These contaminants include various additives and other polymers. The inability to remove such contaminants down to a specific concentration makes the output of these processes rapidly unusable in virgin-like applications. Most of existing technologies can handle certain types of contaminants up to a certain level, however the variety of additives and the amount of polymer combinations found in modern packaging or products makes these technologies rapidly un-adapted. In addition, their inability to produce outputs that can compete against virgin products often makes these technologies economically unfavorable.

Another difficulty with polymer recycling is related to the diversity of polymers found in the mixture of polymer wastes. There are heteropolymers that are formed by the combination of various types of monomers of different nature (like PET, acrylates, synthetic rubbers, urethanes). These polymers are particularly difficult to recycle, even using advanced chemical recycling techniques because the degradation of the heteropolymers create a mixture of complex molecules and therefore increases the complexity of the monomer purification. In fact, heteropolymers yield a wide range of monomers making it exponentially difficult to isolate each individual monomer at a commercial purity level.

There are also other types of polymers, homopolymers (like polyolefins, polystyrene, polyamides), that contain only one type of monomer repeated a certain number of times along the polymer chain, but for which the depolymerization processes are either not selective enough to produce a commercially viable products or ends up producing a monomer that is too difficult to handle. A typical example are polyolefins where a majority of thermo-degradation processes applied to polypropylene or polyethylene produces naphthas, waxes and fuels of low market value.

In summary, the presence of contaminants or polymer additives either limits the application of certain types of technologies to certain qualities of feedstock, or completely makes certain types of technologies inapplicable. For example, some additives can be easily removed by dissolution technologies, but most polymer soluble contaminants are not removed by these technologies. For example, dyes and pigments are very difficult to remove using dissolution techniques since these dyes and pigments are usually soluble in the polymer and the solvent used for dissolution, making this process unqualified for the feedstock with such additives. This is why, most dissolution technologies are applied to white plastics, usually containing inorganic pigments and fillers such as talc and titanium oxides, that are insoluble in the solvent and therefore easily separable from the polymer using conventional solvent extraction and precipitation techniques.

In mechanical recycling processes, only certain types of co-polymers and additives can be removed, and such processes usually require several steps of successive mechanical separation steps like aerial density-based separation, optical separation using infrared absorption, water flotation separating polymers of various densities). These technologies are therefore incomplete.

In physico-chemical extraction processes, several steps of extraction and precipitation are required in order to increase the purity of the polymer-rich precipitate to remove contaminants, additives and/or co-polymers at an acceptable level. In most processes, these steps of purification of the desired polymer are complex and incomplete so that traces of contaminants, additives and co-polymers remain present in the final product.

In chemical recycling technologies, the presence of specific additives may create problems in the process by producing undesirable by-products that will either accumulate in the process due to the absence of proper removal technologies or be released with the non-condensable fraction and generate atmospheric emissions. For example, halogen-based fire retardants, when decomposed in a pyrolysis reactor, will produce brominated compounds in the by-products and generate problematic air emissions to the atmosphere. Another example is the presence of nanocrystals of titanium oxides that may accumulate in the reactor because of the inability to filter out nanoparticles of that dimension. It is therefore desired to remove these additives from the feedstock in those types of applications to prevent problematic emissions.

While chemical recycling technologies are good solutions for specific polymers like polyethylene terephthalate (PET) and polystyrene (PS), these technologies are not easily deployable to other more common polymers like polyolefins and have not yet demonstrated a strong economical differentiator.

For those polymers where chemical recycling technologies produce an output of questionable quality or low market value, solvent extraction is one of the preferred alternatives for physical purification of these polymers. For at least some solvent extraction processes, the recovery of a desired polymer starts by dissolving the plastic mixture into a solvent in which the desired polymer is preferably soluble. After various coagulation/agglomeration steps for removing non-soluble contaminants, the desired polymer is precipitated using an anti-solvent. The anti-solvent is selected carefully to selectively precipitate the desired polymer fraction, but not any other undesirable products. The precipitate is expected to have higher purity than the initial mixture. The steps of dissolution/precipitation are often repeated several times to further increase the purity of the final precipitate.

However, the main disadvantage of solvent-extraction technologies is related to the solvent and anti-solvent selection. For example, a precise selection of the solvent and anti-solvent is required, and the selection is precisely designed for a certain type of product, which makes the solvent extraction process sensitive to variations in the mixture composition. Also, the solubilities are often impacted by the presence of specific contaminants which will change the equilibrium and the overall performance of the solvent extraction process. Such solvent extraction processes usually require several successive purification steps involving various types of solvent, and the resulting purification is usually not perfect. Therefore, several steps of dissolution/precipitation are needed to reach purity levels that are satisfactory. Furthermore, solvent recovery is challenging because of the above-mentioned contamination.

More importantly, some contaminants may have the same solubility as the desired polymer in the solvent/anti-solvent therefore allowing these contaminants to end up in the final precipitate which makes nearly impossible the removal of some types of contaminants while using a solvent extraction process.

By noting that most of the additives found in polymers have a relatively high market value, it could be valuable to recover those additives. In addition, the recovery of impurities such as additives from polymer waste for further purification could generate substantial additional value to the recycling of polymers, potentially making polymer recycling economically viable. For example, pigments and dyes found in plastic waste can be of attractive market value and can create a valuable stream of products. The inability of existing technologies to recover additives in a manner that allows for further purification and extraction of individual additives for valorization is therefore a problem.

Therefore, there is a need for an improved method and system for recycling polymer waste that have a variety of contaminants and a variable composition in time.

There is also a need for a method that allows for recovery of additives in a manner that allows isolation of individual additives for further valorization.

### SUMMARY

According to a broad aspect, there is provided a method for extracting a target polymer from a contaminated polymer compound, the method comprising: dissolving the contaminated polymer compound using a given solvent, thereby obtaining a dissolved polymer mixture: microfiltering the dissolved polymer mixture to remove non-soluble contaminants having a size larger that a size of the target polymer from the dissolved polymer mixture; thereby obtaining a permeate microfiltered polymer solution; and extracting the given solvent from the permeate microfiltered polymer solution, thereby obtaining a feedstock of the target polymer.

In one embodiment, the method further comprises, prior to said extracting the given solvent, ultrafiltering the permeate microfiltered polymer solution to remove soluble contaminants having a size smaller that the size of the target polymer from the permeate microfiltered polymer mixture, thereby obtaining a retentate ultrafiltered polymer solution and a permeate ultrafiltered solution, said extracting the given solvent comprising extracting the given solvent from the retentate ultrafiltered polymer solution to obtain the feedstock of the target polymer.

In one embodiment, the step of extracting the solvent comprises heating the retentate ultrafiltered polymer solution at a temperature at least equal to a fusion temperature of the target polymer.

In one embodiment, the method further comprises extracting the given solvent from the permeate ultrafiltered solution, thereby obtaining soluble contaminants.

In one embodiment, the method further comprises diafiltering the retentate ultrafiltered polymer solution prior to said extracting the given solvent, thereby obtaining a retentate diafiltered solution and a permeate diafiltered solution, said extracting the given solvent comprising extracting the given solvent from the retentate diafiltered solution.

In one embodiment, the step of extracting the solvent comprises heating the retentate diafiltered solution at a temperature at least equal to a fusion temperature of the target polymer.

In one embodiment, the method further comprises extracting the given solvent from the permeate diafiltered solution, thereby obtaining soluble contaminants.

In one embodiment, the method further comprises using at least a portion of the permeate diafiltered solution obtained from said diafiltering the retentate ultrafiltered polymer solution as a further solvent for said dissolving the contaminated polymer compound.

In one embodiment, the method further comprises using at least a portion of the permeate ultrafiltered solution obtained as an additional solvent for said dissolving the contaminated polymer compound.

In one embodiment, the method further comprises diafiltering the permeate microfiltered polymer solution prior to said extracting the given solvent, thereby obtaining a diafiltered retentate and a diafiltered permeate, said extracting the given solvent comprising extracting the given solvent from the diafiltered retentate.

In one embodiment, the step of extracting the solvent comprises heating the diafiltered retentate at a temperature at least equal to a fusion temperature of the target polymer.

In one embodiment, the method further comprises extracting the given solvent from the permeate diafiltered solution, thereby obtaining soluble contaminants.

In one embodiment, the method further comprises using the diafiltered permeate obtained from said diafiltering the permeate microfiltered polymer solution as a further solvent for said dissolving the contaminated polymer compound.

In one embodiment, the contaminated polymer compound comprises the target polymer and at least one further polymer and the solvent is chosen so as to dissolve only the target polymer, said microfiltering the dissolved polymer mixture allowing to remove the at least one further polymer from the dissolved polymer mixture.

In one embodiment, the step of extracting the solvent comprises heating the permeate microfiltered polymer solution at a temperature at least equal to a fusion temperature of the target polymer.

In one embodiment, the target polymer comprises an oligomer.

In one embodiment, the oligomer has a molecular size being at least one order of magnitude greater than soluble impurities contained in the contaminated polymer compound.

According to another broad aspect, there is provided a system for extracting a target polymer from a contaminated polymer compound, the method comprising: a dissolving unit for dissolving the contaminated polymer compound using a given solvent to obtain a dissolved polymer mixture: a microfiltering unit fluidly connected to the dissolving unit for receiving the dissolved polymer mixture therefrom, the microfiltering unit being configured for microfiltering the dissolved polymer mixture to remove non-soluble contaminants having a size larger that a size of the target polymer from the dissolved polymer mixture to obtain a permeate microfiltered polymer solution; and an extracting unit fluidly connected to the microfiltering unit for extracting the given solvent from the permeate microfiltered polymer solution, thereby obtaining a feedstock of the target polymer.

In one embodiment, the system further comprises an ultrafiltering unit fluidly connected between the microfiltering unit and the extracting unit, the ultrafiltering unit being configured ultrafiltering the permeate microfiltered polymer solution to remove soluble contaminants having a size smaller that the size of the target polymer from the permeate microfiltered polymer mixture and obtain a retentate ultrafiltered polymer solution and a permeate ultrafiltered solution, the extracting unit being configured for extracting the given solvent from the retentate ultrafiltered polymer solution to obtain the feedstock of the target polymer.

In one embodiment, the extracting unit is configured for heating the retentate ultrafiltered polymer solution at a temperature at least equal to a fusion temperature of the target polymer.

In one embodiment, the system further comprises an extraction unit for extracting the given solvent from the permeate ultrafiltered solution to obtain soluble contaminants.

In one embodiment, the system further comprises a diafiltering unit fluidly connected between the ultrafiltering unit and the extracting unit, the diafiltering unit being configured for diafiltering the retentate ultrafiltered polymer solution to obtain a retentate diafiltered solution and a permeate diafiltered solution, the extracting unit being configured for extracting the given solvent from the retentate diafiltered solution.

In one embodiment, the extracting unit is configured for heating the retentate diafiltered solution at a temperature at least equal to a fusion temperature of the target polymer.

In one embodiment, the system further comprises an extraction unit for extracting the given solvent from the permeate diafiltered solution to obtain soluble contaminants.

In one embodiment, the diafiltering unit is fluidly connected to the dissolving unit for using at least a portion of the permeate diafiltered solution as a further solvent for dissolving the contaminated polymer compound.

In one embodiment, the ultrafiltering unit is fluidly connected to the dissolving unit for using at least a portion of the permeate ultrafiltered solution as an additional solvent for dissolving the contaminated polymer compound.

In one embodiment, the system further comprises a diafiltering unit fluidly connected between the microfiltering unit and the extracting unit, the diafiltering unit being configured for diafiltering the permeate microfiltered polymer solution to obtain a diafiltered retentate and a diafiltered permeate, the extracting unit being configured for extracting the given solvent from the diafiltered retentate.

In one embodiment, the extracting unit is configured for heating the diafiltered retentate at a temperature at least equal to a fusion temperature of the target polymer.

In one embodiment, the diafiltering unit is fluidly connected to the dissolving unit for using at least a portion of the permeate diafiltered solution as a further solvent for dissolving the contaminated polymer compound.

In one embodiment, the system further comprises an extraction unit for extracting the given solvent from the permeate diafiltered solution to obtain soluble contaminants.

In one embodiment, the contaminated polymer compound comprises the target polymer and at least one further polymer and the solvent is chosen so as to dissolve only the target polymer, the microfiltering unit being configured for removing the at least one further polymer from the dissolved polymer mixture.

In one embodiment, the extracting unit is configured for heating the permeate microfiltered polymer solution at a temperature at least equal to a fusion temperature of the target polymer.

In one embodiment, the target polymer comprises an oligomer.

In one embodiment, the oligomer has a molecular size being at least one order of magnitude greater than soluble impurities contained in the contaminated polymer compound.

According to a further broad aspect, there is provided a method for extracting contaminants from a contaminated polymer compound, the method comprising: dissolving the contaminated polymer compound using a given solvent, thereby obtaining a dissolved polymer mixture: microfiltering the dissolved polymer mixture to remove non-soluble impurities having a size larger that a size of the target polymer from the dissolved polymer mixture: thereby obtaining a retentate microfiltered solution; and extracting the given solvent from the retentate microfiltered solution, thereby obtaining the contaminants.

According to still another broad aspect, there is provided a system for extracting contaminants from a contaminated polymer compound, the method comprising: a dissolving unit for dissolving the contaminated polymer compound using a given solvent, thereby obtaining a dissolved polymer mixture: a microfiltering unit fluidly connected to the dissolving unit for receiving the dissolved polymer mixture therefrom, the microfiltering unit being configured for microfiltering the dissolved polymer mixture to remove non-soluble impurities having a size larger that a size of the target polymer from the dissolved polymer mixture: thereby obtaining a retentate microfiltered solution; and an extracting unit fluidly connected to the microfiltering unit for extracting the given solvent from the retentate microfiltered solution, thereby obtaining the contaminants.

According to still a further broad aspect, there is provided a method for extracting contaminants from a contaminated polymer compound, the method comprising: dissolving the contaminated polymer compound using a given solvent, thereby obtaining a dissolved polymer mixture: microfiltering the dissolved polymer mixture to remove non-soluble impurities having a size larger that a size of the target polymer from the dissolved polymer mixture: thereby obtaining a permeate microfiltered polymer solution and a retentate microfiltered solution: ultrafiltering the permeate microfiltered polymer solution to remove soluble impurities having a size smaller that the size of the target polymer from the permeate microfiltered polymer mixture, thereby obtaining a retentate ultrafiltered polymer solution and a permeate ultrafiltered solution; and extracting the given solvent from the permeate ultrafiltered solution, thereby obtaining the contaminants.

In one embodiment, the method further comprises extracting the given solvent from the retentate microfiltered solution, thereby obtaining further contaminants.

According to still another broad aspect, there is provided a system for extracting contaminants from a contaminated polymer compound, the method comprising: a dissolving unit for dissolving the contaminated polymer compound using a given solvent, thereby obtaining a dissolved polymer mixture: a microfiltering unit fluidly connected to the dissolving unit for receiving the dissolved polymer mixture therefrom, the microfiltering unit being configured for microfiltering the dissolved polymer mixture to remove non-soluble impurities having a size larger that a size of the target polymer from the dissolved polymer mixture: thereby obtaining a permeate microfiltered polymer solution and a retentate microfiltered solution: an ultrafiltering unit fluidly connected between the microfiltering unit, the ultrafiltering unit being configured for ultrafiltering the permeate microfiltered polymer solution to remove soluble impurities having a size smaller that the size of the target polymer from the permeate microfiltered polymer mixture and obtain a retentate ultrafiltered polymer solution and a permeate ultrafiltered solution; and an extracting unit fluidly connected to the ultrafiltering unit for extracting the given solvent from the permeate ultrafiltered solution, thereby obtaining the contaminants.

In one embodiment, the system comprising an extraction module for extracting the given solvent from the retentate microfiltered solution, thereby obtaining further contaminants.

According to a further broad aspect, there is provided a method for extracting contaminants from a contaminated polymer compound, the method comprising: dissolving the contaminated polymer compound using a given solvent, thereby obtaining a dissolved polymer mixture: microfiltering the dissolved polymer mixture to remove non-soluble impurities having a size larger that a size of the target polymer from the dissolved polymer mixture: thereby obtaining a permeate microfiltered polymer solution and a retentate microfiltered solution: ultrafiltering the permeate microfiltered polymer solution to remove soluble impurities having a size smaller that the size of the target polymer from the permeate microfiltered polymer mixture, thereby obtaining a retentate ultrafiltered polymer solution and a permeate ultrafiltered solution: diafiltering the retentate ultrafiltered polymer solution, thereby obtaining a retentate diafiltered solution and a permeate diafiltered solution; and extracting the given solvent from at least one of the permeate ultrafiltered solution and the permeate diafiltrated solution, thereby obtaining the contaminants.

In one embodiment, the method further comprises extracting the given solvent from the retentate microfiltered solution, thereby obtaining further contaminants.

According to still a further broad aspect, there is provided a system for extracting contaminants from a contaminated polymer compound, the method comprising: a dissolving unit for dissolving the contaminated polymer compound using a given solvent, thereby obtaining a dissolved polymer mixture: a microfiltering unit fluidly connected to the dissolving unit for receiving the dissolved polymer mixture therefrom, the microfiltering unit being configured for microfiltering the dissolved polymer mixture to remove non-soluble impurities having a size larger that a size of the target polymer from the dissolved polymer mixture: thereby obtaining a permeate microfiltered polymer solution and a retentate microfiltered solution: an ultrafiltering unit fluidly connected between the microfiltering unit, the ultrafiltering unit being configured for ultrafiltering the permeate microfiltered polymer solution to remove soluble impurities having a size smaller that the size of the target polymer from the permeate microfiltered polymer mixture and obtain a retentate ultrafiltered polymer solution and a permeate ultrafiltered solution: a diafiltering unit fluidly connected between the ultrafiltering unit, the diafiltering unit being configured for diafiltering the retentate ultrafiltered polymer solution to obtain a retentate diafiltered solution and a permeate diafiltered solution; and an extracting unit fluidly connected to at least one of the ultrafiltering unit and the diafiltering unit for extracting the given solvent from at least one of the permeate ultrafiltered solution and the permeate diafiltered solution, thereby obtaining the contaminants.

In one embodiment, the system further comprises an extraction module for extracting the given solvent from the retentate microfiltered solution, thereby obtaining further contaminants.

It should be understood that the expression “size of a compound”, such as the size of a polymer, the size of an oligomer, the size of a contaminant, etc., refers to the molecular size of the compound, i.e., the size of the molecule of the compound.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

In the following, it should be understood that impurities contained in a polymer comprise additives and/or contaminants. Additives usually comprise chemicals added to the base polymer during manufacturing and compounding to improve processability, prolong the life span of the polymer, achieve a desired physical or chemical properties in the final product, and/or the like. Additives are contained in the polymer matrix. For example, additives comprise dyes, pigments, flame retardants, etc.

Contaminants include chemicals or element added to or retained in the polymer during its transformation to a product, its usage and/or its end-of-life process. Examples of contaminants comprise metal, paper, other polymer(s), sand, dirt, liquid chemicals, etc.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a low chart illustrating a method for recycling polymer from a contaminated polymer compound, in accordance with an embodiment;

FIG. 2 is a block diagram illustrating a system for recycling polymer from a contaminated polymer compound, in accordance with a first embodiment; and

FIG. 3 is a block diagram illustrating a system for recycling polymer from a contaminated polymer compound, in accordance with a second embodiment.

FIG. 4 is a block diagram illustrating an exemplary experimental filtration setup for filtering polystyrene.

FIG. 5 is an exemplary graph illustrating a filtration efficiency versus a membrane pore size obtained while using the experimental setup of FIG. 4.

FIG. 6 is an exemplary graph illustrating an average molecular weight of polystyrene in a permeate fluid versus a membrane pore size obtained using the experimental setup of FIG. 4.

### DETAILED DESCRIPTION

In the following, there is presented a method and system for purifying a target or desired polymer from a compound, such as plastic waste, comprising the target polymer and impurities based on the size or the size range of the target polymer molecules or chains and its solubility into a specific solvent. The impurities usually comprise additives and contaminants which may include other polymers. Furthermore, the method may also allow for the recovery of impurities such as additives for future valorization. For example, the inventors have noted that the impurities usually present in waste plastic mixture or compound have a size that is either smaller than the typical size of a polymer molecule (which is usually comprised between about 10 kDa and about 1,500 kDa) or greater than the typical size of a polymer molecule. Typically, the size of impurities contained in waste plastic mixtures is either below 1,000 Da or greater than 100 nm. Therefore, it is possible to mechanically extract the polymer molecules from a waste plastic mixture based on the size of the polymer molecules, i.e., by filtering the waste plastic mixture to remove the impurities that have a size smaller than that of the polymer molecules and the impurities that have a size greater than that of the polymer molecules.

In addition, the inventors have noted that polymers usually have variable solubilities in different solvents. Therefore, it is possible to dissolve only a target or desired polymer comprised in a mixture containing different polymers (i.e. the target polymer and co-polymers) by adequately choosing the solvent in which the mixture is to be dissolved. The solvent is chosen to dissolve the desired polymer, but not the co-polymers, i.e., all of the other polymers contained in the mixture. As a result of the dissolution, the desired polymer is dissolved in a liquid while the other polymers remain in a solid state. It is then possible to mechanically extract the desired polymer from the mixture of polymers by properly selected filtration membranes. The mixture containing the dissolved desired polymer and the insoluble polymers is passed through at least one filtration membrane. The dissolved phase containing the desired polymer and the solvent passes through the filtration membrane while the insoluble phase containing the insoluble polymers is blocked by the filter and remains on the retentate side of the membrane. By adequately selecting the membrane pore size and the solvent, it is then possible to isolate the desired polymer and remove the other co-polymers.

Therefore, in one embodiment, the proposed process allows for removing impurities, including additives and contaminants such as co-polymers, by dissolving a mixture of polymer-containing feedstock or mixture into a properly selected solvent in combination with a size-exclusion process such as a membrane filtration process (e.g., ultrafiltration, nanofiltration).

In one embodiment, the removed impurities are concentrated to allow further purification thereof. The purification of the concentrated impurities or contaminants may involve techniques such as filtration, membrane filtration, extraction, chromatography, crystallization, evaporation, distillation, floatation, sedimentation, centrifugation, sieving, magnetic separation, mechanical separation, refining (electrorefining, electrowinning) and/or the like.

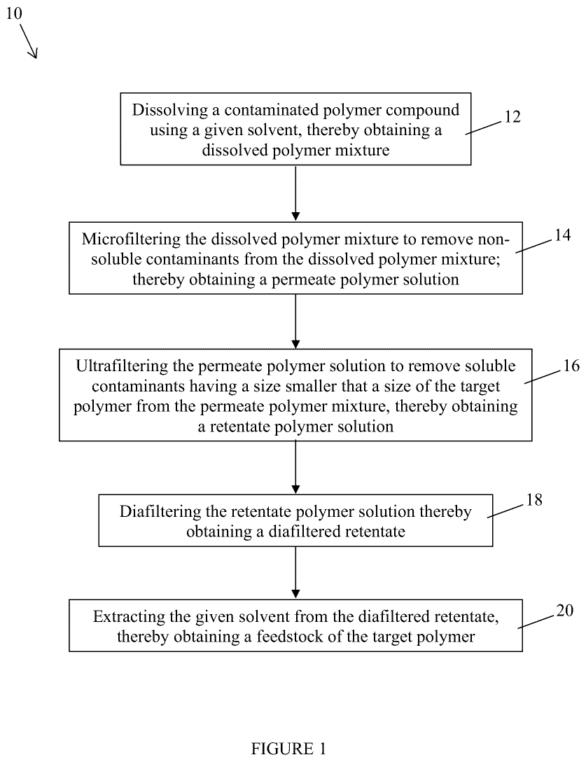

FIG. 1 illustrates one embodiment of a method 10 for recycling a desired or target polymer from a contaminated compound comprising solid aggregates of the target polymer and impurities. The contaminated compound may be a waste plastic mixture made of or comprising the target polymer and other polymers, i.e., co-polymers, and/or impurities such as organic or inorganic contaminants and additives for example. The size of the molecules of the target polymer is comprised within a given range and the size of the different impurities is assumed to be either below the given range or above the given range.

Examples of target polymers that can be extracted from a mixture using the method 10 include: PET, HDPE, PS, PP, PMMA, Nylon 66 (Polyamide), Nylon 6 (Polyamide), PVC, POM-h, ABS and the like. Table 1 presents some characteristics for some polymers that can be extracted from a mixture using the method 10.

TABLE 1
Characteristics of some target polymers.

| | Functional unit | # of functional | Molecular |
|---|---|---|---|
| Polymer type | Mw | units | weight (kg/mol) |
| PET | 192 | 50-300 | 10-50 |
| HDPE | 28 | 3,500-9,000 | 100-250 |
| PS | 104 | 1,000-4,000 | 100-400 |
| PP | 42.08 | 5,000-97,000 | 12-340 |
| PMMA | 100.121 | 1,100-1,470,000 | 1.2-1,760 |
| Nylon 66 | 226.32 | 10,000-30,000 | 2,200-6,800 |
| (Polyamide) | | | |
| Nylon 6 | 113.16 | 10,000-30,000 | 1,100-3,400 |
| (Polyamide) | | | |
| PVC | 62.5 | ~99,000 | ~233 |
| POM-h | 30.031 | | |
| ABS | | 51,000 | 105 |

In one embodiment, the polymer to be recycled comprises an oligomer. In one embodiment, the oligomer has a molecular size which is at least one order of magnitude larger or less than that of the contaminants or impurities to be extracted.

Examples of impurities that can be extracted from a contaminated polymer compound using the method 10 comprise: organic and inorganic dyes and pigments (such as titanium oxide, carbon black, iron oxides, chrome oxides, dioxazines, anthraquinone, azo, cyanines, cobalt blue, ultramarine blue, naphtol, rutile yellow, chrome oxide green, pyrroles), fillers (such as carbon fibers, silica, talc, quartz, glass beads, kaolin), stabilizers (such as halides, chlorides, fluorides), fire retardants (such as Polybrominated diphenyl ethers PBDE, tetrabromobisphenol A TBBPAetrabromobisphenol A TBBPA, Tris(2-chloroethyl)phosphate(TCEP), Tris(2-chlorisopropyl)phosphate (TCPP)), various stabilizers (such as salicylates, benzotriazoles, benzophenones, resorcinols), lubricants (such as stearic acid, stearates, stearamides, ketones), plasticizers (such as phtaltes and sulfonamides) and/or the like.

TABLE 2
Characteristics of some typical contaminants.

| | | | Molecular weight |
|---|---|---|---|
| Name | CAS | Category | (g/mol) |
| Titanium dioxide | 13463-67-7 | Dyes and pigment | 79 |
| Carbon black | 1333-86-4 | Filler (1-100 | 12.011 |
| | | microns) | |
| Hexabromocyclododecane | α; 134237-50-6 | Flame retardant | 641.7 |
| (mixture of 3 stereoisomers alpha, | β; 134237-51-7 | | |
| beta & gamma) | γ; 134237-52-8 | | |
| DecaBDE | 1163-19-5 | Flame retardant | 959.17 |
| Carbon fibers | | Fillers | |
| Amorphous silica | | Fillers | 60.08 |
| Polybrominated diphenyl ethers | | Flame retardants | |
| PBDE | | | |
| PentaBDE | 32534-81-9 | | 564.69 |
| OctaBDE | 32536-52-0 | | 801.31 |
| DecaBDE | 1163-19-5 | | 959.22 |
| tetrabromobisphenol A TBBPA | 79-94-7 | Flame retardants | 543 |
| 1,2-Bis(pentabromophenyl) ethane | 84852-53-9 | Flame retardant | 971.22 |
| Tris(2- | 5961-85-3 | Flame retardant | 250 |
| chloroethyl)phosphate(TCEP) | | | |
| Tris(2-chlorisopropyl)phosphate | 13674-87-8 | Flame retardant | 430 |
| (TCPP) | | | |
| 1,2,3,4,5,6- | 1837-91-8 | Flame retardant | 557.54 |
| HEXABROMOCYCLOHEXANE | | | |
| Kaolin and calcined kaolin. | 1332-58-7 | Filler | 258.16 |
| Talc (Magnesium hydroxide) | 1309-42-8 | Filler | 58.32 |
| Calcium silicates (wollastonite) | 13983-17-0 | Filler | 118.18 |
| Glass beads (silicon dioxide) | | Filler | 60.08 |

At step 12, the contaminated polymer compound is mixed with a given solvent to dissolve the solid aggregates of target polymer. It will be understood that the given solvent is chosen to dissolve the target polymer. For example, the solvent may be water, acetone, nitric acid, methyl ethyl ketone, acetone, ethylbenzene or the like and is chosen based on the target polymer to be dissolved. As a result of the dissolution step 12, a dissolved polymer mixture is obtained. It should also be understood that some of the impurities contained in the contaminated polymer compound may also be dissolved by the given solvent while other impurities may not be dissolved by the given solvent, thereby remaining in a solid form. As a result, the dissolved polymer mixture comprises the target polymer in a liquid form, some impurities in a liquid form and other impurities in a solid form.

It should be understood that a combination of solvents can be used at step 12 for dissolving the solid aggregates of the target polymer.

In one embodiment, the step 12 comprises heating the contaminated polymer compound and the solvent to improve the dissolution of the target polymer in the solvent.

At step 14, the dissolved polymer mixture obtained at step 12 is microfiltered, i.e., the dissolved polymer mixture is passed through a microfilter, to remove non-soluble impurities contained in the dissolved polymer mixture such as talc, glass powder, carbon black and/or the like. The microfilter comprises pores or apertures extending therethrough and the pore size of the microfilter is chosen so as to allow some elements contained in the dissolved polymer mixture having a size being less than a predefined size to pass through the microfilter while other elements contained in the dissolved mixture having a size being larger than the predefined size to be blocked by the microfilter. The pores of the microfilter are provided with the predefined size which is chosen as a function of the size of the target polymer molecules, i.e., the size of the pores of the microfilter is chosen to allow the target polymer molecules to pass therethrough. In one embodiment, the size of the pores is chosen so as to be at least equal to the size of the target polymer molecules. For example, the size of the pores may be slightly larger than the size of the target polymer molecules. In an embodiment in which the size of the target polymer molecules is comprised within a given size range, the predefined size for the pores of the microfilter is chosen to be at least equal to the maximal limit of the given size range of target polymer molecules. For example, the size of the pores may be slightly larger than the maximal limit of the given size range of target polymer molecules.

As a result of the microfiltration step 14, a permeate microfiltered polymer solution and a retentate microfiltered solution are obtained. The permeate microfiltered polymer solution corresponds to the elements of the dissolved polymer mixture that passed through the microfilter while the retentate microfiltered solution corresponds to the elements of the dissolved polymer of the dissolved that were retained by the microfilter. The permeate microfiltered polymer solution contains the solvent, the target polymer and any other soluble elements having a size smaller than that of the apertures of the microfilter such as impurities having a size smaller than that of the apertures of the microfilter.

In one embodiment, step 14 of the method 10 further comprises adding solvent on the retentate side of the microfilter to maximize the recovery of the desired polymer. The addition of solvent on the retentate side of the microfilter allows for additional transportation of the desired polymer through the membrane in the permeate and maximize the recovery of the desired polymer.

While in the above, the step 14 of microfiltering the dissolved polymer mixture is performed using a microfilter comprising at least one membrane of which the pores have an adequate size, it should be understood that any other adequate method may be used for extracting elements having a size comprised in the micron range. For example, the microfiltering of the dissolved polymer mixture may be performed using a decanter or a centrifuge. In one embodiment, the step 14 further comprises adding a coagulant or agglomerant to the dissolved polymer mixture to accelerate and facilitate the removal of the non-soluble elements contained in the dissolved polymer mixture. The addition of the coagulant or agglomerant increases the size of the non-soluble impurities through agglomeration which facilitate the removal of the non-soluble impurities using a centrifuge or a decanter. When a centrifuge or a decanter is used for performing the step of microfiltration of the dissolved polymer mixture, the centrate or clarified solution obtained from the decanter or centrifuge process corresponds to the permeate microfiltered polymer solution.

At step 16, the permeate microfiltered polymer solution obtained at step 14 is ultrafiltered, i.e., the permeate microfiltered polymer solution is filtered using a semipermeable membrane, to remove impurities having a size smaller than that of the target polymer molecules, such as pigments, fire retardants, plasticizers and/or the like. The membrane is chosen to allow only elements having a size smaller than the size of the target polymer molecules, such as at least some additives, to pass therethrough while elements having a size equal to or larger than the size of the target polymer molecules, such as the target polymer molecules, cannot pass through the membrane.

As a result of the ultrafiltration, a permeate ultrafiltered solution and a retentate ultrafiltered polymer solution are obtained. The permeate ultrafiltered solution comprises all of the elements of the permeate microfiltered polymer solution that passed through the membrane while the retentate ultrafiltered polymer solution contains all of the elements of the permeate microfiltered polymer solution that did not pass through the membrane, including the target polymer molecules. The retentate ultrafiltered polymer solution comprises the target polymer molecules and the permeate microfiltered solution comprises the impurities, such as additives, having a size smaller than that of the target polymer molecules.

In one embodiment, the retentate ultrafiltered polymer solution comprises target polymer molecules, solvent and further impurities.

In this case, the next step 18 of the method 10 consists in diafiltering the retentate ultrafiltered polymer solution to remove impurities having a size smaller than that of the target polymer molecules. During the diafiltering or dialysis step, further solvent is added to the retentate ultrafiltered polymer solution from step 16 to dilute the contaminants and obtain a mixture that is passed through an ultrafiltration membrane. In one embodiment, the pores of the ultrafiltration membrane used at step 18 for diafiltering the retentate ultrafiltered polymer solution is substantially identical to the size of the pores of the membrane used at step 16 for ultrafiltering the permeate microfiltered polymer solution. It will be understood that at step 18 the volume of added solvent may be chosen as a function of a desired purity level for the retentate diafiltered solution. It will also be understood that the more solvent is to be added to the retentate ultrafiltered polymer solution, the purer the retentate diafiltered solution will be. In one embodiment, the solvent that is added at step 18 is the same solvent that the one used at step 12. In another embodiment, the solvent added at step 18 is different from that used at step 12.

Alternatively, to reduce the use of fresh solvent, the diafiltration step 18 may comprise a series of diafiltration membranes operating counter-currently taking the permeate from the next diafiltration step to dilute the retentate from the previous step. In other words, if the process comprises N diafiltration steps, the fresh solvent would be added to the N^{th} step and the permeate of the first diafiltration step would be the output containing the highest concentration of contaminants.

As a result of the diafiltering step 18, a retentate diafiltered solution and a permeate diafiltered solution are obtained. The permeate diafiltered solution contains impurities while the retentate diafiltered solution contains the target polymer molecules and solvent with the desired level of contaminants, i.e. with the desired purity.

Then the solvent is extracted from the retentate diafiltered solution to obtain a target polymer feedstock at step 20. In one embodiment, the retentate diafiltered solution is heated at a given temperature to evaporate the solvent from retentate diafiltered solution. The given temperature is chosen to allow adiabatic devolatilization of the solvent to obtain a desolventized feedstock of target polymer at a temperature equal to or above the polymer glass transition temperature or melting of the target polymer. The molten and desolventized polymer can then be processed such as being extruded into pellets or fed to a chemical recycling process or stored into a heated container for example. It should be understood that the solvent is chosen so that its boiling temperature be less than the meting temperature of the target polymer, as shown in Table 3.

TABLE 3
Target polymers and respective adequate solvents.

| | | Solvent | Polymer |
|---|---|---|---|
| | | boiling T | melting T |
| Polymer | Solvent | (° C.) | (° C.) |
| Polystyrene | Acetone | 56 | 200-240 |
| | Toluène | 110.6 | |
| | Ethylbenzene | 136 | |
| | Styrene | 145 | |
| | Chloroform | 61.2 | |
| | Limonene | 176 | |
| Polyethylene | Isooctane | 99 | 85 to 140 |
| | Toluene | 110.6 | |
| | Xylene | 139 | |
| | Trichloroethylene | 87.2 | |
| | Trichlorobenzene | 214.4 | |
| Polypropylene | Xylene | 139 | 130 to 171 |
| | Methylcyclohexane | 101 | |
| | Trichloroethylene | 87.2 | |
| | Trichlorobenzene | 214.4 | |
| PET | 1,1,1,3,3,3, hexafluoro-2- | 58.2 | 250-260 |
| | propanol | | |
| | DMSO | 189 | |
| | Nitrobenzene | 210.9 | |
| | phenol | 181.7 | |
| | o-chlorophenol | 174.9 | |
| Polyamides | Trifluoroacetic acid/acetone | 72.4 | 220 to 270 |
| | mixtures | | |
| | Phenol (Carbolic Acid) | 181.7 | |
| | Calcium chloride-saturated | Mixture | |
| | methanol solution | | |
| | Formic acid | 100.8 | |
| PVC | Tetrahydrofuran | 66 | 100 to 260 |
| | Cyclohexanone | 155.6 | |
| | Cyclopentanone | 131 | |
| PMMA | Acetone | 56 | 160 |
| | Toluene | 110.6 | |
| | Chloroform | 61.2 | |
| | methyl ethyl ketone | 79.6 | |
| POM-h | Hexafluoro-Isopropanol | 58.2 | 180 to 190 |
| | Chlorophenols | 174.9 | |
| | Benzyl alcohol | 205 | |

In another embodiment, the step 18 may be omitted. In this case, the solvent is extracted directly from the retentate ultrafiltered polymer solution obtained at step 16. This may be the case when the permeate microfiltered polymer solution comprises only target polymer molecules and solvent, or when the level of impurities in the retentate ultrafiltered polymer solution is acceptable.

In a further embodiment, the step 16 is omitted. In this case, the permeate microfiltered polymer solution is directly diafiltered at step 18 without performing the ultrafiltration step 16.

In still another embodiment, the steps 16 and 18 are omitted. In this case, the solvent is directly extracted from the permeate microfiltered polymer solution at step 20 without performing the steps 16 and 18.

In one embodiment, the method 10 further comprises a step of extracting the solvent from the retentate microfiltered obtained at step 14 to recover the impurities contained therein. The recovered impurities may have a great value and may further be treated to isolate specific compounds, such as copolymers, talc, titanium oxide, aluminum, etc., for further valorization. The recovered impurities comprise the impurities that were not dissolved in the solvent and have a size that is greater than that of the target polymer.

In one embodiment, the method 10 further comprises a step of extracting the solvent from the permeate ultrafiltered solution obtained at step 16 to recover the impurities that were present with the target polymer. The recovered impurities may have a great value and may further be treated to isolate specific compounds, such as additives, for further valorization. The recovered impurities comprise the soluble impurities that were dissolved in the solvent and have a size that is smaller than that of the target polymer.

In one embodiment, the method 10 further comprises a step of extracting the solvent from the permeate diafiltered solution obtained at step 18 to recover the impurities that were present with the target polymer. The recovered impurities may have a great value and may further be treated to isolate specific compounds, such as additives, for further valorization. The recovered impurities comprise the impurities that were dissolved in the solvent and have a size that is smaller than that of the target polymer.

In one embodiment, the method 10 further comprises a step of extracting the solvent from the retentate microfiltered solution obtained at step 14 to recover the contaminants such as the co-polymers that were not dissolved by the solvent. This stream may be further extracted by another solvent in order to isolate and purify the other polymers present and apply the same process at step 12 with a different solvent that will be deemed compatible with the desired polymer.

In one embodiment, the method further comprises a grinding step performed prior to the dissolution step 12. For example, raw plastic material may be received and grinded to obtain a grinded material. The grinded material is then processed to remove large size contaminants such as labels, paper, etc. For example, a primary filtration step may be performed to remove the large size contaminants, or a centrifuge can be used for removing the large size contaminants.

In one embodiment, the contaminated polymer compound comprises at least an additional polymer in addition to the target polymer, i.e., at least one co-polymer. If only the target polymer is to be recycled, the additional polymer(s) is(are) not dissolved at step 12. Since different polymers have different solubilities in different solvents, it is possible to adequately choose the given solvent used at step 12 so as to dissolve only the target polymer but not the additional polymer(s) which remain(s) in a solid state. In this case, the microfiltration performed at step 14 allows for removing the additional polymer from the dissolved polymer mixture by retaining the solid additional while the dissolved polymer may pass through the microfilter. Alternatively, the additional polymer may be removed from the dissolved polymer mixture by centrifugation.

For example, if the contaminated polymer mixture contains polyethylene and polypropylene, a solvent that dissolves only polypropylene such as acetone may be used in order to dissolve only polypropylene, thereby preventing polyethylene from flowing through the membranes with the dissolved polypropylene during the microfiltering step and allowing separation of polyethylene and polypropylene from one another. In another example in which the contaminated polymer mixture contains polypropylene and polystyrene, methyl ethyl ketone may be used as a solvent to selectively dissolve polystyrene but not polypropylene. It should be understood that more than one dissolution step may be used to separate polymers. In an example in which the contaminated polymer mixture contains a mixture of polyethylene, EVOH and PET (which is a typical combination of polymers found in multilayer packaging), toluene is first used to selectively dissolve the polyethylene contained in the contaminated polymer mixture while EVOH and PET are not dissolved. The thus-obtained mixture containing dissolved polyethylene is passed through a semi-permeable membrane to remove impurities from the polyethylene rich solution. The polyethylene-depleted solution obtained from that first filtration step then contains EVOH and PET and is contacted with DMSO to selectively dissolve EVOH which will then go through another filtration step to remove impurities from the EVOH rich solution.

By adequately selecting the solvent to dissolve a contaminated polymer mixture, it is possible to separate polymers such as polyethylene, polypropylene, polyethylene terephthalate, polystyrene, nylon, polymethylmethacrylates, acrylonitrile butadiene styrene (ABS), Acrylics, PVC, Polycarbonates, Styrene Acrylonitrile, ethylvinyl alcohol (EVOH), and the like so that only a target polymer be dissolved. For example, when several polymers are present in a contaminated polymer mixture, the selected solvent may be adequate for dissolving the primary polymer contained in the contaminated polymer mixture.

In one embodiment, the method 10 further comprises a step of recirculating at least a portion of the retentate microfiltered solution obtained at step 14, the permeate ultrafiltered solution obtained at step 16 and/or the permeate diafiltered solution obtained at step 18 to be used as a further solvent at step 12. Such a recirculation allows for a reduction of the quantity of solvent required for the method 10. For example, the permeate diafiltered solution may be used as an additional solvent for the dissolution of the contaminated polymer compound occurring at step 12. Such a recirculation of the permeate diafiltered solution will increase the concentration of impurities in the permeate ultrafiltered solution and reduce the energy needed for devolatilization of the solvent.

In one embodiment, the steps of microfiltration, ultrafiltration and diafiltration are performed using respective semipermeable membranes. The membrane(s) used for the microfiltration step 14 comprise(s) pores having a size in the micrometer or nanometer range. The membranes used for the ultrafiltration step 16 and the diafiltration step 18 comprise pores having a size in the nanometer range.

In one embodiment, the method 10 which includes the microfiltration and ultrafiltration steps along with an optional diafiltration step allows a simple and efficient removal of impurities using geometrical differences between the polymer and the impurities without having strong dependency on variable thermodynamic characteristics which are incumbent to other dissolution/precipitation techniques. The method 10 reduces the complexity and sensitivity related to conventional dissolution/crystallization processes. Such dissolution/crystallization processes are generally specific to target impurities, meaning that the solvents are perfectly selected to extract specific impurities. Therefore, if new contaminants enter the system, they may not be properly handled by the dissolution/crystallization process and possibly cause some concerns and lack of performances with the solvent recovery processes.

In one embodiment, the use of membranes to remove impurities such as other co-polymers allows a better control of feedstock quality since impurities such as other co-polymers are known to cause several issues in downstream chemical recycling technologies such as glycolysis, hydrolysis or pyrolysis.

In one embodiment, the method 10 allows chemical recycling technologies to use more contaminated feedstocks that require less preparation which may reduce cost and logistics of material.

In one embodiment, the method 10 allows reduction of impurities that may accumulate in recycle loops of chemical recycling technologies, which may have a significant impact on purge streams and operation downtime.

In one embodiment, the method 10 allows recycling of polymers that cannot be valorized via a depolymerization approach, such as some homopolymers composed of only one monomer like polyolefins and polyamides as well as most heteropolymers formed by more than one monomer, like acrylonitrile-butadiene styrene (ABS), Styrene-Butadiene Rubber (SBR), Styrene-butadiene-styrene (SBS), polyurethanes, epoxides and/or polycarbonates, by restoring the quality recycled polymer without losing value, performance, and quality.

In one embodiment, the method 10 offers an approach to recycle laminates of various polymers by specifically dissolving one specific target polymer using the appropriate solvent.

In at least some prior art approaches in which solvent extraction alone is used, the nature of the equilibrium is such that perfect solubilities or complete insolubilities of species are never total, meaning that traces of impurities may accumulate over time in one or the other continuous phase and create a problem after some time. Such as problem may be avoided by using the method 10, mainly by combining the extraction with a series of size exclusion processes (microfiltration and ultrafiltration) and with a diafiltration step.

In at least some other adsorption processes, there is a specificity of the media as in the points above. Additionally, there is a need for regeneration of the adsorbent when the adsorbent material is saturated and potentially having to change that media frequently. This may end up being costly. Such a problem may be avoided by using the method 10.

In one embodiment, the method 10 offers a separation based on molecular size which can be suitable for a wide range of contaminants since most contaminants are about 2 orders of magnitude in size smaller than the polymer itself. Therefore, having a size exclusion-based process such as method 10 using multiple membrane arrangement can be more robust for dealing with impurities, and can be easily regenerated when the membranes are saturated.

In one embodiment, the method 10 allows for recovering impurities such as additives that are soluble in the polymer (such as pigments, plasticizers, fire retardants, etc.) that cannot be recovered using conventional methods. For example, in solvent extraction processes, most polymer soluble additives cannot be extracted distinctively from the polymer since the solvent used to dissolve the polymer usually has affinities with the additives soluble in the polymer. Therefore, conventional methods cannot effectively remove additives that are soluble in the polymer and therefore cannot recover these additives from the polymer. The proposed method 10 allows for the removal of polymer soluble additives by using the fact that these additives usually have a molecular size significantly smaller than the polymer molecular size by using a combination of ultrafiltration and/or diafiltration steps.

While the above method refers to the decontamination of a contaminated polymer compound to extract a target polymer therefrom, the method may also be adapted to extract elements from a depolymerization product containing oligomer molecules having a molecular size smaller than that of a typical polymer molecule. As mentioned above and in one embodiment, the oligomer has a molecular size that is at least one order of magnitude greater than that of the contaminants and impurities.

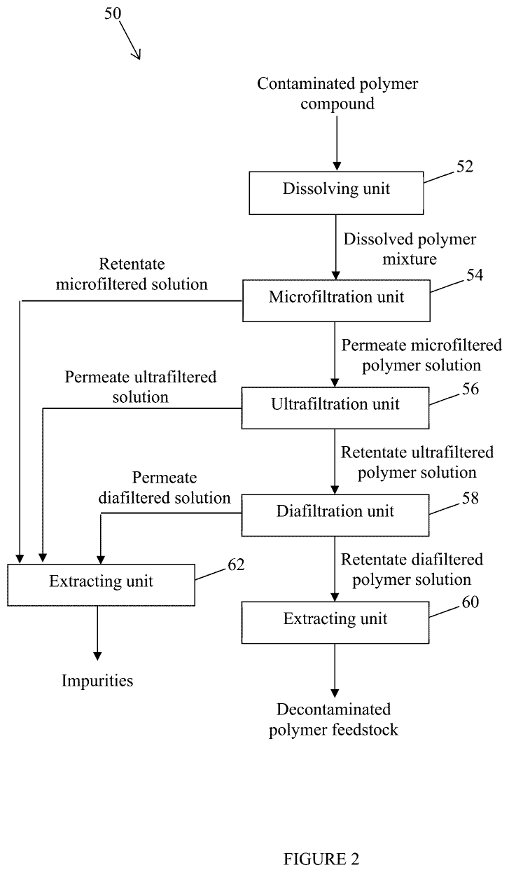

FIG. 2 schematically illustrates one embodiment of a system 50 for purifying a desired or target polymer from a contaminated compound comprising solid aggregates of the target polymer and impurities. The contaminated polymer compound may be a waste plastic mixture made of or comprising the target polymer and impurities such as other polymers, i.e., co-polymers, additives, and organic or inorganic contaminants for example. The size of the molecules of the target polymer is comprised within a given range and the size of the different contaminants is either below the given range or above the given range.

The system 50 comprises a dissolving unit 52, a microfiltration unit 54, an ultrafiltration unit 56, a diafiltration unit 58 and an extracting unit 60.

The dissolving unit 52 is fluidly connected to a source of solvent and configured for receiving the contaminated polymer compound and the solvent therein and dissolving the contaminated polymer compound in the solvent, i.e., dissolving the target polymer contained in the contaminated compound in the solvent to obtained a dissolved mixture. The microfiltration unit 54 is fluidly connected to the dissolving unit 52 for receiving the dissolved mixture therefrom and configured for microfiltering the dissolved mixture so as to remove elements having a size greater than the size of the target polymer molecules and obtain a microfiltered permeate that contains the solvent, the target polymer and contaminants. The ultrafiltration unit 56 is fluidly connected to the microfiltration unit 54 for receiving the microfiltered permeate therefrom and configured for ultrafiltering the microfiltered permeate so as to remove the contaminants therefrom to obtain an ultrafiltered retentate that contains the solvent and the target polymer. The diafiltering unit 58 is fluidly connected to the ultrafiltering unit 56 to receive the ultrafiltered retentate therefrom and configured to diafilter the ultrafiltered retentate to obtain a diafiltered retentate that contains the solvent and the target polymer. The extracting unit 60 is fluidly connected to the diafiltering unit 58 to receive the diafiltered retentate therefrom and configured to extract the solvent from the diafiltered retentate to obtain a feedstock of target polymer.

In one embodiment and as illustrated in FIG. 2, the system 50 further comprises a second extracting unit 62 fluidly connected to the ultrafiltration unit 56 and/or the diafiltration unit 58 for receiving therefrom the permeate ultrafiltered solution and/or the permeate diafiltered solution, respectively. The second extracting unit 62 allows for extracting the solvent from the permeate ultrafiltered solution and/or the permeate diafiltered solution to extract the impurities collected by the ultrafiltration unit 56 and/or the diafiltration unit 58. As mentioned above, the extracted impurities may have a great value and may further be treated to isolate specific impurities such as additives for further valorization.

It should be understood that any adequate fluidic connections such as pipes can be used for fluidly connecting the different components of the system 50. It should also be understood that pumps may be connected to the fluidic connections to propagate the compounds from one unit to another.

It should be understood that any adequate dissolving unit 52 adapted to mix a solvent and the contaminated polymer compound together so as to dissolve the target polymer in the solvent may be used.

In one embodiment, the dissolving unit 52 comprises a stirred tank in which the contaminated polymer compound and the solvent are fed. In one embodiment, the tank is hermetical. In this case, the tank may be provided with a sas system (e.g., an air-lock valve such as a rotary valve) so as to ensure that no air enters into the tank and/or no solvent emissions are leaking outside of the tank.

In one embodiment, the tank is provided with a heating system for heating the solvent and the contaminated compound contained therein so as to increase the solubility of the target polymer in the solvent.

In one embodiment, the dissolving unit 52 comprises a plurality of tanks fluidly connected together to ensure complete solubility of the target polymer in the solvent before propagation to the microfiltration unit 54. For example, the dissolving unit 52 may comprise a first tank might be in dissolution mode while a second tank is feeding to dissolved mixture to the microfiltration unit 54.

It should be understood that any adequate microfiltration unit 56 adapted to microfilter a dissolved mixture can be used. In one embodiment, the microfiltration unit 56 comprises at least one membrane having pores of which the size is in the micron range. As described above, the size of the pores is chosen so as to be larger than the size of the molecules of the target polymer so as to allow the solvent and the dissolved target polymer to flow through the membrane. In one embodiment, the membrane is installed within a pipe fluidly connected to the dissolving unit 52 and pump is used for propagating the dissolved compound within the pipe from the dissolving unit 52 towards the membrane. In another embodiment, the microfiltration unit 54 further comprises an enclosure in which the membrane is mounted. The enclosure is fluidly connected to the dissolving unit 52 on the retentate side of the membrane and to the ultrafiltration unit 56 on the permeate side of the membrane.

In one embodiment, the microfiltration unit 54 comprises a bank of tubular membranes that operate in crossflow configuration. For example, the bank may comprise a balance tank and a pump that loops through the membrane. Once a certain concentration is reached, the product is bypassed to either another membrane loop or to a receiving tank comprised in the microfiltration unit 54.

In another embodiment, the microfiltration unit 54 comprises a decanter or a centrifuge. As described above, the dissolved mixture is injected into the decanter or the centrifuge and a coagulant or agglomerant may be added to the dissolved mixture to accelerate and facilitate the removal of the non-soluble elements contained in the dissolved mixture. When a centrifuge or a decanter is used for performing the step of microfiltration of the dissolved polymer mixture, the centrate or clarified solution obtained from the decanter or centrifuge process corresponds to the microfiltered permeate.

It should be understood that any adequate ultrafiltration unit 56 for ultrafiltering the microfiltered permeate received from the microfiltration unit 54 may be used. As described above, the ultrafiltering of the microfiltered permeate allows for elements contained in the microfiltered permeate and having a size being less than the size of the molecules of the target polymer to pass therethrough. In one embodiment, the ultrafiltration unit 56 comprises at least one ultrafiltration membrane of which the pores have a size that is less than that of the molecules of the target polymer. Similarly to the microfiltration unit 54, the ultrafiltration membrane may be mounted into a pipe fluidly connected to the microfiltration unit 54 for receiving the microfiltered permeate therefrom. In another embodiment and also similarly to the microfiltration unit 54, the ultrafiltration unit 56 may comprise an enclosure in which the membrane is mounted.

In a further embodiment, the ultrafiltration unit 56 comprises a bank of tubular ultrafiltration membranes that operate in crossflow configuration. For example, the bank may comprise a balance tank and a pump that loops through the membrane. Once a certain concentration is reached, the product is bypassed to either another membrane loop or to a receiving tank comprised in the ultrafiltration unit 56.

For example, during the ultrafiltration step, the product may be looped on the membrane until a certain concentration of total solid is reached, then the system will bypass the concentrated retentate to the next balance tank feeding the diafiltration skid. Diafiltration solvent may be added to the balance tank of the diafiltration skid to dilute the retentate from the ultrafiltration skid and the product may be looped until a desired purity is reached. Only then, the retentate from the diafiltration skid is sent to a receiving tank holding the final product before desolventization.

It should be understood that any adequate diafiltration unit 58 for diafiltering the ultrafiltered retentate received from the ultrafiltration unit 56 may be used. In one embodiment, the ultrafiltration unit 56 comprises at least one diafiltration membrane of which the pores have a size that is less than that of the molecules of the target polymer. Similarly to the microfiltration unit 54 or the ultrafiltration unit 56, the diafiltration membrane may be mounted into a pipe fluidly connected to the ultrafiltration unit 56 for receiving the ultrafiltered retentate therefrom. In another embodiment and also similarly to the microfiltration unit 54 or the ultrafiltration unit 56, the diafiltration unit 58 may comprise an enclosure in which the diafiltration membrane is mounted.

In a further embodiment, the diafiltration unit 58 comprises a bank of tubular diafiltration membranes that operate in crossflow configuration. For example, the bank may comprise a balance tank and a pump that loops through the diafiltration membrane. Once a certain concentration is reached, the product is bypassed to either another membrane loop or to a receiving tank comprised in the diafiltration unit 58.

In one embodiment, the diafiltration unit 58 is fluidly connected to a source of solvent so as to add solvent to the ultrafiltered retentate.

It should be understood that any adequate extracting unit 60, 62 for extracting the solvent from a solution can be used. For example, the extracting unit 60 may comprise an enclosure in which the diafiltered retentate is received and a heating system for heating the diafiltered contained within the enclosure so as to evaporate the solvent.

In one embodiment, the ultrafiltration unit 56 and the diafiltration unit 58 are omitted so that the permeate side of the microfiltration unit 54 is fluidly connected to the extracting unit 60.

In another embodiment, the ultrafiltration unit 54 is omitted so that the permeate side of the microfiltration unit 54 is fluidly connected to the diafiltration unit 58.

In a further embodiment, the diafiltration unit 58 is omitted so that the retentate side of the ultrafiltering unit 56 is connected to the extracting unit 60.

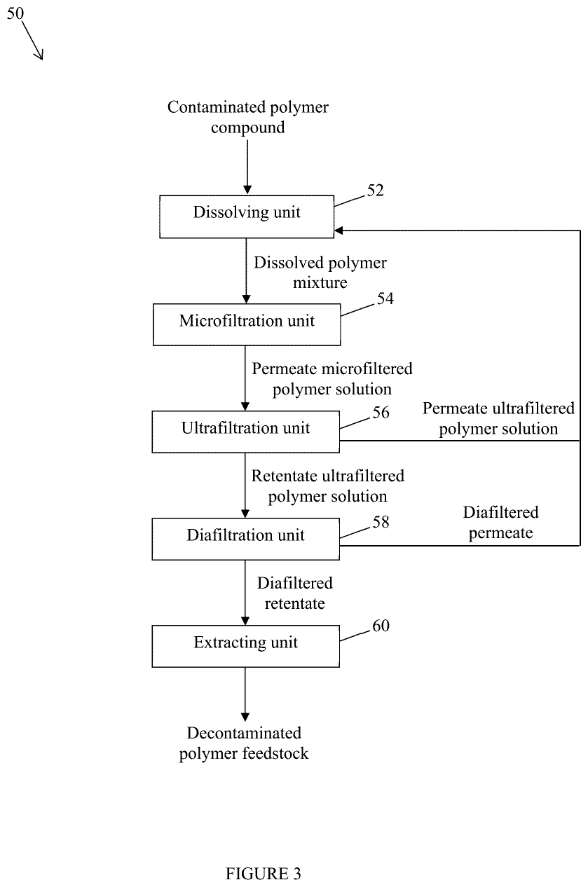

In one embodiment, the retentate side of the microfiltering unit 54 is fluidly connected to the dissolving unit 52 so as to inject the microfiltered retentate into the dissolving unit 52, as illustrated in FIG. 3.

In the same or another embodiment, the permeate side of the ultrafiltration unit 56 is fluidly connected to the dissolving unit 52 so as to inject the ultrafiltered permeate into the dissolving unit 52, as illustrated in FIG. 3.

In one embodiment, the permeate side of the diafiltration unit 58 is fluidly connected to the dissolving unit 52 so as to inject the diafiltered permeate into the dissolving unit 52, as illustrated in FIG. 3.

In one embodiment, the extracting unit 60 is fluidly connected to the dissolving unit 52 so as to propagate the evaporated solvent into the dissolving unit 52.

In one embodiment, the microfiltering membrane(s), the ultrafiltering membrane(s) and/or the diafiltering membrane(s) are made of ceramic. Such ceramic membranes can usually sustain a broader range of solvents and temperature conditions. They are also more robust to the presence of impurities and can be restored by heating the membranes in presence of oxygen so as to remove the impurities through combustion.

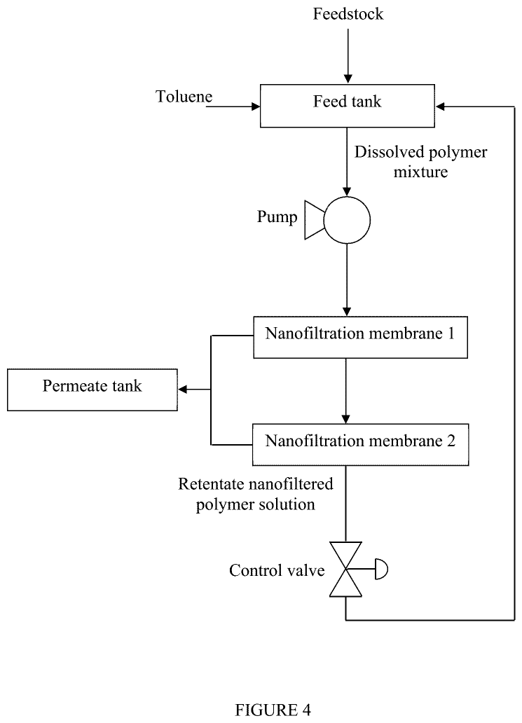

In the following, experimental results obtained using the pilot-scale membrane filtration system of FIG. 4 are presented. The system comprised a 25 liter feed tank, a pump, two ceramic cross-flow membrane modules in series (each comprising a nanofiltration membrane), a control valve and a permeate tank. The feed tank fed into the pump, which delivered a desired pressure and flow rate. The flow from the pump then passed through the membrane modules (module 1 and module 2). The retentate flowed out of the membrane modules and was re-circulated back to the feed tank. A control valve downstream of the membrane modules was adjusted to build a pressure in the membrane modules and the system was operated at several pressures (up to 100 psig) by adjusting the pump speed and the control valve opening. Adjusting the pressure inside the membrane modules allowed us to control the crossflow across the filtration membranes.

A 30-mesh filter was installed before the pump to prevent potential damage to the membranes by large particles. The pressure at various parts of set-up, flow rates of permeate and retentate, and temperature of fluids were monitored and recorded by digital pressure indicators, flowmeters, and thermometers, respectively.

The process was entirely controlled by a control panel that allowed the operator to adjust different setpoints such as the flow rate and the pressure. Once the process was activated on the control panel, the feed solution (i.e., polymer dissolved in a solvent) was pumped out of the feed tank and through the ceramic nanofiltration membranes. As the pressurized feed traveled through the membrane, the solution's components having a diameter smaller than the membrane's pores diffused laterally through the membrane to form the permeate while larger polymeric molecules remained behind and formed the retentate. The permeate can then be isolated by opening permeate valves and collected into the permeate tank.

A series of experiments were performed where polystyrene (PS) was used as the solute for the membrane filtration process whereas toluene (density=0.8668 g/ml at 22° C.) was used as the solvent. The PS had a polydispersity of 2.5, a weight average molecular weight (Mw) of 365000 g/mol and its decomposition temperature was 421° C. From thermogravimetric analysis (TGA), the moisture, volatile matter, fixed carbon, and ash content were 0.01 wt. %, 99.97 wt. %, 0.00 wt. % and 0.02 wt. %, respectively. Both the solute and the solvent were weighed to match a desired concentration and were dissolved in the feed tank and homogenized by means of an electric agitator. During the tests, the feedstock concentration had a PS content [PS/(PS+toluene)] of 3.25 wt. % and a density of 0.8725 g/ml at 22° C.

To initiate the filtration experiment, the permeate valves (not shown) were closed and the solution was circulated through the filtration system for at least 5 minutes and the pressure setpoint was reduced to a value around 10 psi before taking samples. The feed samples were the first ones collected and were taken out of the collecting point located right before the entrance of the ceramic membrane. After another 5 minutes, the permeate samples were collected by opening the valves located laterally to the membranes. To increase the permeate flow, the pressure setpoint could be increased. Several permeate samples were taken a few minutes apart. Finally, the concentrate samples were taken at the very end out of the same collecting point that was used to collect the feed samples. In addition, certain verification experiments were performed to ensure that the set-up worked as expected. In these experiments, the operational parameters such as the pressure setpoint, the flow rate, the temperature as well as values given by the different pressure indicators placed on the piping were recorded for each sample analysed and the tests were repeated couple of times to verify repeatability and quantify the variability of the results.

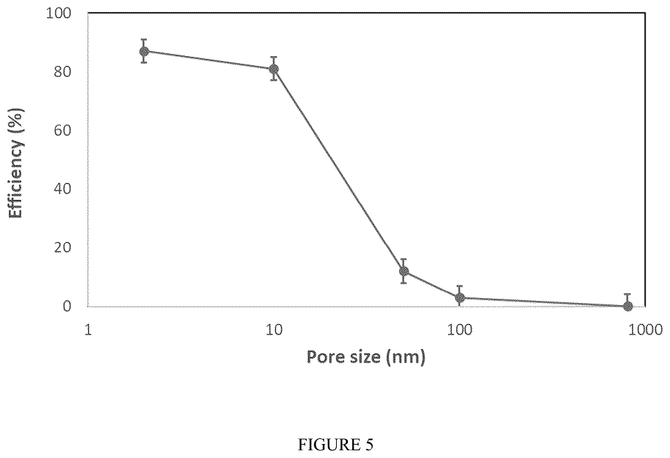

FIG. 5 illustrates the efficiency of the filtration membrane setup of FIG. 4 to extract PS from toluene as a function of membrane pore size, while the rest of parameters were fixed. The efficiency is defined as

$$\frac{{Ps}_{feed} - {Ps}_{Permeate}}{{Ps}_{Feed}} \times 100.$$

The membrane pore size had a significant impact on the efficiency and decreasing the pore size from 800 nm to 2 nm increased the efficiency from almost 0.1% to 87%.

A polymer chain size is a function of polymer molecular weight. Depending on the polymer's molecular weight, a polymer's structure and the nature of the solvent in which it is dissolved, the dissolved polymer molecules can have a different hydrodynamic volume in the solution (i.e., volume of the polymer sphere). In other words, unlike small molecules, polymers are typically a mixture of different chain length molecules, and they have a broad spectrum of molecular weight. It means that for the filtration membrane tests, the molecular weight of the polymers in solutions that can pass through the membrane (permeate fluid), strongly depend on membrane pore size because polymer molecules with higher values of hydrodynamic radius are not able pass through the membrane.

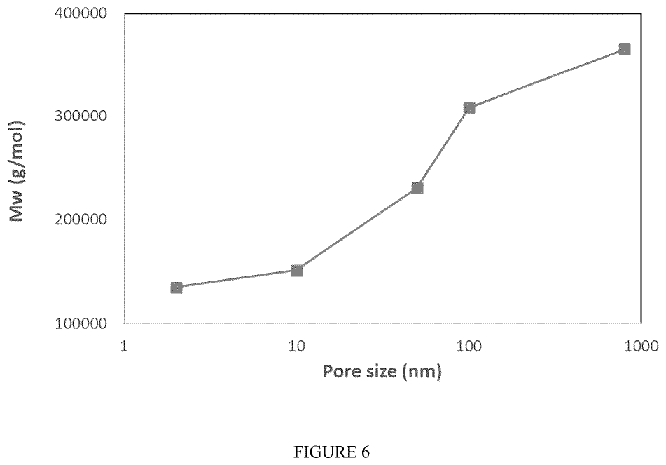

FIG. 6 illustrates the variation of average molecular weight of PS in the permeate fluid versus the membrane pore size. As illustrated in FIG. 6, the molecular weight of PS in the permeate fluid is affected by the membrane pore size. By decreasing the pore size from 800 nm to 2 nm, the molecular weight of PS in the permeate fluid decreased from almost 365000 g/mol to 135000 g/mol, finding that the membrane pore size can control both the efficiency of extracting PS from toluene (as shown in FIG. 5) and the weight average molecular weight of PS in the permeate phase (as shown in FIG. 6).

Polystyrene can be used as thermal insulation in the building industry. Then, in order to reduce the flammability of PS, it is mixed with a brominated flame retardant. Hexabromocyclododecane (HBCD) is intensively used worldwide as a brominated flame retardant additive. HBCD is a small molecule (Mw=641.7 g/mol) compared to PS and its decomposition temperature is 262° C.

In order to perform the experimental tests based on a HBCD solution, 2 nm ceramic nanofiltration membrane was used in the system of FIG. 4. HBCD powder was dissolved in toluene. The new feedstock concentration was

$$\frac{HBCD}{HBCD + Toluene} = 2.69 wt . \% ,$$

and its density was 0.8863 g/ml at 22° C. The solution was prepared in the feed tank and then flowed through the filtration system. It was demonstrated that a 2 nm membrane cannot extract HBCD from toluene so that the concentration of HBCD in the feedstock is more or less similar to that in the permeate and retentate phases. The conclusions that may be drawn from these results is that almost 13% of PS can pass through the 2 nm membrane while for HBCD is about 100%. Therefore, it is possible to separate PS from a flame retardant additive by size exclusion.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Modifications and improvements to the above-described implementations of the present technology may become apparent to those skilled in the art. The foregoing description is intended to be exemplary rather than limiting.

1-50. (canceled)

51. A method for extracting contaminants from a contaminated polymer compound, the method comprising:
dissolving the contaminated polymer compound using a given solvent, thereby obtaining a dissolved polymer mixture;
microfiltering the dissolved polymer mixture to remove non-soluble impurities having a size larger than a size of the target polymer from the dissolved polymer mixture, thereby obtaining a permeate microfiltered polymer solution;
diafiltering the permeate microfiltered polymer solution, thereby obtaining a retentate diafiltered solution and a permeate diafiltered solution;
using at least a portion of the permeate diafiltered solution as a further solvent for said dissolving the contaminated polymer compound; and
extracting the given solvent from the retentate diafiltered solution, thereby obtaining a feedstock of the target polymer.

52. The method of claim 51, wherein said extracting the given solvent comprises heating the retentate diafiltered solution at a temperature at least equal to a fusion temperature of the target polymer.

53. The method of claim 51, further comprising extracting the given solvent from the permeate diafiltered solution, thereby obtaining first soluble impurities.

54. The method of claim 53, wherein the first soluble impurities comprise first additives.

55. The method of claim 51, wherein said diafiltering the permeate microfiltered polymer solution comprises:
ultrafiltering the permeate microfiltered polymer solution to remove soluble impurities having a size smaller than the size of the target polymer from the permeate microfiltered polymer mixture, thereby obtaining a retentate ultrafiltered polymer solution and a permeate ultrafiltered solution; and
diafiltering the retentate ultrafiltered polymer solution to obtain the retentate diafiltered solution and the permeate diafiltered solution.

56. The method of claim 55, further comprising using at least a portion of the permeate ultrafiltered solution as an additional solvent for said dissolving the contaminated polymer compound.

57. The method of claim 55, further comprising extracting the given solvent from the permeate ultrafiltered solution, thereby obtaining second soluble impurities.

58. The method of claim 51, wherein the contaminated polymer compound comprises the target polymer and at least one further polymer, and the given solvent is chosen so as to dissolve only the target polymer, said microfiltering the dissolved polymer mixture allowing to remove the at least one further polymer from the dissolved polymer mixture.

59. The method of claim 58, wherein the target polymer comprises an oligomer.

60. The method of claim 59, wherein the oligomer has a molecular size being at least one order of magnitude greater than soluble impurities contained in the contaminated polymer compound.

61. A system for extracting contaminants from a contaminated polymer compound, the system comprising:
a dissolving unit for dissolving the contaminated polymer compound using a given solvent to obtain a dissolved polymer mixture;
a microfiltering unit fluidly connected to the dissolving unit for receiving the dissolved polymer mixture therefrom, the microfiltering unit being configured for microfiltering the dissolved polymer mixture to remove non-soluble impurities having a size larger than a size of the target polymer from the dissolved polymer mixture to obtain a permeate microfiltered polymer solution;
a diafiltering unit fluidly connected between the microfiltering unit, the diafiltering unit being configured for diafiltering the permeate microfiltered polymer solution to obtain a diafiltered retentate and a diafiltered permeate, the extracting unit being configured for extracting the given solvent from the diafiltered retentate; and
an extracting unit fluidly connected to the diafiltering unit for extracting the given solvent from the diafiltered retentate solution, thereby obtaining a feedstock of the target polymer,
wherein the diafiltering unit is fluidly connected to the dissolving unit for using at least a portion of the permeate diafiltered solution as a further solvent for dissolving the contaminated polymer compound.

62. The system of claim 61, wherein the extracting unit is configured for heating the diafiltered retentate at a temperature at least equal to a fusion temperature of the target polymer.

63. The system of claim 61, further comprising an extraction unit for extracting the given solvent from the permeate diafiltered solution to obtain first soluble impurities.

64. The system of claim 63, wherein the first soluble impurities comprise additives.

65. The system of claim 61, further comprising an ultrafiltering unit fluidly
connected between the microfiltering unit and the diafiltering unit,
wherein the ultrafiltering unit is configured for ultrafiltering the permeate microfiltered polymer solution to remove soluble impurities having a size smaller that the size of the target polymer from the permeate microfiltered polymer mixture and obtain a retentate ultrafiltered polymer solution and a permeate ultrafiltered solution, and
wherein the diafiltering unit is configured for diafiltering the retentate ultrafiltered polymer solution to obtain the retentate diafiltered solution and the permeate diafiltered solution.

66. The system of claim 65, wherein the ultrafiltering unit is fluidly connected to the dissolving unit for using at least a portion of the permeate ultrafiltered solution as an additional solvent for dissolving the contaminated polymer compound.

67. The system of claim 65, further comprising an extracting unit extracting the given solvent from the permeate ultrafiltered solution to obtain second soluble impurities.

68. The system of claim 61, wherein the contaminated polymer compound comprises the target polymer and at least one further polymer, and the given solvent is chosen so as to dissolve only the target polymer, the microfiltering unit being configured for removing the at least one further polymer from the dissolved polymer mixture.

69. The system of claim 68, wherein the target polymer comprises an oligomer.

70. The system of claim 69, wherein the oligomer has a molecular size being at least one order of magnitude greater than soluble impurities contained in the contaminated polymer compound.
